(19) United States
(12) Patent Application Publication
(10) Pub. No.: US 2014/0301662 A1
(43) Pub. Date: Oct. 9, 2014

(54) Analysis, Labeling and Exploitation of Sensor Data in Real Time

(71) Applicant: ISC8 Inc., Costa Mesa, CA (US)

(72) Inventors: James Justice, Newport Beach, CA (US); David Ludwig, Irvine, CA (US); Medhat Azzazy, Irvine, CA (US); Virgilio Villacorta, Corona, CA (US); Hoang Le, Irvine, CA (US)

(21) Appl. No.: 14/215,222

(22) Filed: Mar. 17, 2014

Related U.S. Application Data
(60) Provisional application No. 61/802,700, filed on Mar. 17, 2013.

(51) Int. Cl. G06T 7/00

(52) U.S. Cl. CPC G06T 7/003
USPC 382/278

(57) ABSTRACT

A method for processing sensor data representative of a scene of interest. A plurality of sensor data outputs representative of the scene is selected from the group consisting of visible, VNIR, SWIR, MWIR, LWIR, far infrared, multi-spectral data, hyper-spectral data, SAR data, and 3-D LIDAR sensor data. The data is input to a plurality of graphics processing elements that are configured to independently execute separate image processing filter operations selected from the group consisting of spatial filtering, temporal filtering, spatio-temporal filtering, and template matching. A cross-correlation operation is performed on the filter outputs based on predetermined filter output characteristics which may then be used to annotate the scene with regions of interest (ROI) for display to a user.

### CROSS-REFERENCE TO RELATED APPLICATIONS

This application claims the benefit of U.S. Provisional Patent Application No. 61/802,700, filed on Mar. 17, 2013 entitled “Analysis, Labeling, and Exploitation of Data in Real Time for Hyper-spectral Sensors” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of image processing. More specifically, the invention relates to a device and method for identifying salient features in a scene by analyzing video image data of the scene which may be in the form of a plurality of spectral ranges in the electromagnetic spectrum which may include LWIR, SWIR, NIR, visible, hyper-spectral sensor data or any user-selected spectral range or combination of ranges.

User-selected attributes in the scene are identified by concurrently running a plurality of image processing algorithms in a plurality of graphics processing units where the algorithms may be a set selected from spatial, temporal or spatio-temporal filters or convolutions on the image data which, in part, may emulate the image processing of the human visual cortex.

2. Background of the Invention

Advances are needed in the performance of state-of-the art in signal processors used in the analysis of Intelligence, Reconnaissance, and Surveillance (ISR) data to the point where signal processing technologies can apply analytical techniques to ISR sensor data streams and determine salient or user-defined content of interest in the sensor stream, such as video data, to ISR sensor system users substantially in real time.

Wide-area surveillance (WAS) is an increasingly important function for both military operations and homeland security missions.

Two problems limit the effectiveness of current and emerging WAS sensor systems. The first problem wises because current systems operate primarily by operator observations of video data streams. Operator fatigue rapidly degrades effectiveness. Further, as surveillance assets increase, associated operator costs rise.

The second problem arises because advances in focal plane array technologies have enabled surveillance sensors to rapidly increase their pixel counts and frame rates, while providing increased surveillance effectiveness through better resolution and wider area coverage. Such systems which form the basis of persistent surveillance concepts produce massive information overload.

Preprocessing of surveillance data to highlight interest and key operator attention is an urgent need to advance the state of the art of image processing and target identification.

What is needed is a system and architecture that exploits neural-inspired, cognitive processing for auto-detection and highlighting of targets of interest within the fields of view of electro-optical perimeter surveillance sensors.

### BRIEF SUMMARY OF THE INVENTION

The invention enables the massive data streams produced by state-of-the-art ISR imaging sensors to be processed in multiple domains, e.g. spatial, temporal, color, and hyper-spectral domains. It further enables the cross-correlation of processed results in each of the above information domains in order to increase confidence in detected areas of activity and to greatly reduce false detections.

The disclosed invention is generally comprised of an assembly of signal processing hardware elements upon which are instantiated processing techniques that accurately emulate the human visual path processing by a) computing the degrees of correlation between elements o the image sensor data streams and sets of spatial, temporal, color and hyper-spectral filters, by comparing the degrees of correlation across the information domains and thereby enabling detection, classification, and by connotation of the targets and target activities of interest for the system operator/analysts in the data streams.

The result is to greatly reduce the “data-to-decision” timelines for the system operator/analysts by processing the massive data flows of ISR sensor systems with negligible latency. The physical characteristics of the invention are such as to enable it to be deployed at existing data exploitation sites such as on larger airborne or seaborne sensor platforms and at mobile and fixed data exploitation centers.

The processing invention enables a high degree of adaptability by optimizing processing operations in response to mission objectives, observing, environments, and collateral data inputs. Near-real time performance is achieved in part by use of certain commercial-off-the-shelf (COTS) processing hardware elements such as FPGAs and GPUs which enable a highly parallel processing architecture.

In a first aspect of the invention, a method for processing sensor data representative of a scene of interest is disclosed comprising the steps of inputting a plurality of sensor data outputs representative of a scene of interest selected from the group consisting of visible, VNIR, SWIR, MWIR, LWIR, far infrared, multi-spectral data, hyper-spectral data, SAR data, and 3-D LIDAR sensor data to a plurality of graphics processing elements. The plurality of elements are configured to independently execute a plurality of separate image processing filter operations selected from the group consisting of spatial filtering, temporal filtering, spatia-temporal filtering, and template matching. The first aspect further comprise concurrently executing the filter operations on the sensor data in each of a plurality of the elements to define a plurality of image filter outputs, performing a cross-correlation operation on the filter outputs based on a predetermined set of filter output characteristics and prioritizing one or more regions of interest (ROI) in the scene based on the cross-correlation operation.

In a second aspect of the invention, at least one of the image processing filter operations is selected from the group consisting of motion, intensity, color, flicker and orientation filter operations.

In a third aspect of the invention, the method further comprises the step of annotating at least one of the regions in the scene.

In a fourth aspect of the invention, the method further comprises the step of outputting at least one of the annotated scenes to a display.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope.

### BRIEF DESCRIPTION OF THE DRAWINGS

FIG. 1 illustrates the application of cognitive models of signal processing that emulate how the human visual path searches and classifies areas of interest based on spatial, temporal, and color processing. FIG. 1 generally illustrates how the processing architecture of the invention may be rendered adaptable by permitting user-defined adjustments in processing steps to the observer mission, observing conditions, and collateral data inputs. This adaptability is a key benefit of the invention.

FIG. 2 shows the general processing architecture of the cognitive processor illustrating the computational accelerators that enable real time operation on a variety of ISR sensor inputs including the hyper-spectral sensor suites which contain visible and infrared imaging sensors as well as sensor channels which produce the highly-detailed spectral data cubes with very many spectral sub-bands (typically >100) characteristic of hyper-spectral sensing.

The invention and its various embodiments can now be better understood by turning to the following description of the preferred embodiments which are presented as illustrated examples of the invention in any subsequent claims in any application claiming priority to this application. It is expressly understood that the invention as defined by such claims may be broader than the illustrated embodiments described below

### DETAILED DESCRIPTION OF THE INVENTION

Turning now to the figures wherein like references define like elements among the several views, Applicant discloses a device and method for identifying salient features in a scene from a set of image data sets or frames with negligible latency approximating real time operation.

Military and commercial users have been developing airborne ISR sensor suites including hyper-spectral imaging sensors or “HIS” sensors for the last twenty years as a means for recognizing targets based upon those targets' unique spectral signatures, However, an unanticipated problem resulted from this development, that is, ISR sensors and especially HSI sensors are extremely high-data output sensors that arc capable of quickly overwhelming the capacity of prior art air-to-ground communications links.

Prior art attempts have partially solved this problem through on-board processing and reporting on a limited subset of those spectral signatures and recording all data for later post-mission analysis.

The assignee of the instant application discloses herein a sensor data processor and architecture for using in an ISR sensor suite which includes HSI sensors that significantly increases the timeliness and effectiveness of the processing, exploitation, dissemination (PET)) of the sensor data.

The invention permits the optimization, and operational deployment of a processor utilizing cognitive image processing principals which analyzes a set of heterogeneous (i.e., different) sensor outputs (imagery and hyper-spectral data cubes) and annotates regions of potential threat or having a pre-determined characteristic at substantially the same rate as the sensor is producing the data. This in turn permits faster analysis by significantly reducing the time required for assessment and distribution of results and by improving the probability of potential threat detection and prioritization.

The invention overcomes the prior art deficiencies by emulating how the human visual path processes large data volumes and identifies regions or targets areas of salient interest.

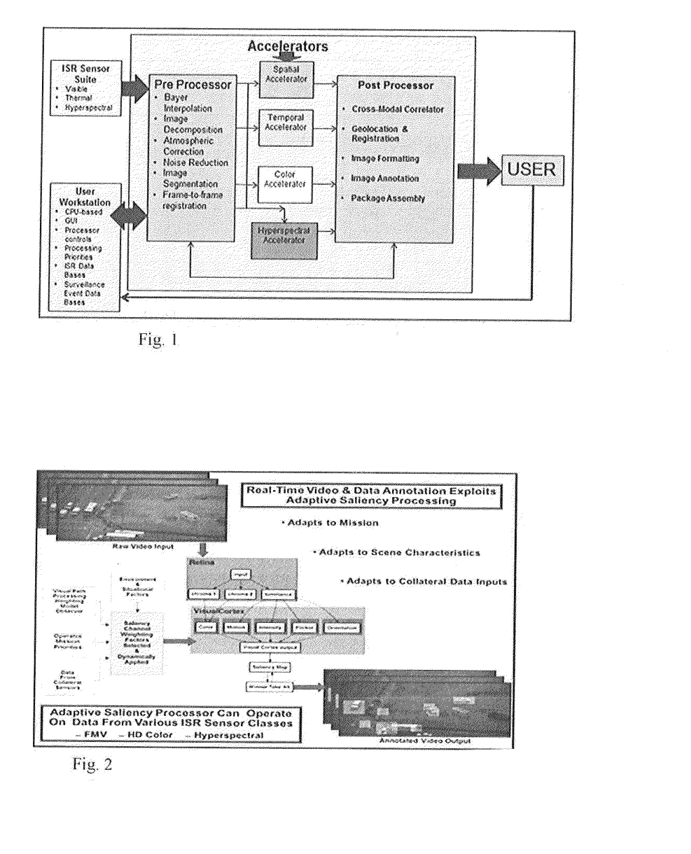

The invention's saliency processing approach, as illustrated in FIG. 1, relies on characterizing the spatial content (size, shape, orientation) and color content of the imagery from multiple spectra and characterizing the hyper-spectral data by determining locations where the spectral content matches that of known objects of interest and where locations show anomalous spectral signatures when compared to adjacent locations. This processing is accomplished in parallel and at an accelerated rate. The state of the art is advanced by development of adaptive features of the processing schema that significantly improve probabilities of detection while significantly reducing false detections.

The next step in the processing architecture is the “cross-modal correlation” of the outputs of the different channels and annotation of regions of potential threat. For example, activities (dismounts, vehicles) and structures (buildings, enclosures, roads) when associated with possible TED locations can assist in determining the level of threat posed to forces.

In order to accomplish the saliency processing approximately at the rate the sensor suite is producing data, i.e. real time, the host processor must have the capability to execute the processing at a rate over ½ billion pixel samples per second.

In this configuration, the invention may be provided to fit in a standard “2U” electronics enclosure, packing a very-high data processing performance using four (4) NVIDIA Tesla K-10 GPUs. The Tesla K10 GPU delivers high performance (4.58 teraflops) and memory bandwidth (320 GB/sec) in a single accelerator. This is approximately 12 times higher single precision flops and 6.4 times higher memory bandwidth than the latest-generation Intel Sandy Bridge CPUs. In this preferred embodiment, the inclusion of a processing host with 48 Gbs of DDR3 Random Access Memory to ensure few systems limitations are experienced across a variety of observing conditions identified.

A preferred processing architecture is illustrated in FIG. 2.

The exploitation of cognitive processing to rapidly search large data streams and databases, determine regions of high priority interest, and alert operator/analysts can lead to significant image processing enhancement by providing improved support for intelligence, surveillance and reconnaissance or “ISR”.

Performance metrics for the system may include; 1) processing of hyper-spectral data and determination of anomalous locations in under one second, 2) processing of hyper-spectral data and determination of locations with template matches to spectral signatures of priority substances in under one second, 3) determination and location of regions displaying specific colors in under one second 4) determination of the presence and locations of dismounts, vehicles, structures, and roads within ne second, 5) cross-correlation of outputs from all hyper-spectral and spatial information channels and prioritization of Regions Of Interest (ROI) based on activity indications and an assessment of threat potential, 6) annotation of ROIs and display to operator/analysts, 7) accomplishment of all above metrics in less than 1.5 seconds, 8) accomplishment of all processing described above at rates ˜500,000,000 pixel samples/sec. The above metrics result in increased timeliness of results presented to system operators and increased probability of successfully determining potential threat locations and associated activities at very low false detection rates.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by any claims in any subsequent application claiming priority to this application.

For example, notwithstanding the act that the elements of such a claim may be set forth in a certain combination, it must be expressly understood that the invention includes other combinations of fewer, more or different elements, which e disclosed in above even when not initially claimed in such combinations.

The words used this specification to describe the invention and its various embodiments are to be understood not only in the sense of their commonly defined meanings, but to include by special definition in this specification structure, material or acts beyond the scope off the commonly defined meanings. Thus, if an element can be understood in the context of this specification as including more than one meaning, then its use in a subsequent claim must be understood as being generic to all possible meanings supported by the specification and by the word itself.

The definitions of the words or elements of any claims in any subsequent application claim priority to this application should be, therefore, defined to include not only the combination of elements which are literally set forth, but all equivalent structure, material or acts for performing substantially the same function in substantially the same way to obtain substantially the same result. In this sense, it is therefore contemplated that an equivalent substitution of two or more elements may be made for any one of the elements in such claims below or that a single element may be substituted for two or more elements in such a claim.

Although elements may be described above as acting in certain combinations and even subsequently claimed as such, it is to be expressly understood that one or more elements from a claimed combination can in some cases be excised from the combination and that such claimed combination may be directed to a subcombination or variation of a subcombination.

Insubstantial changes from any subsequently claimed subject matter as viewed by a person with ordinary skill in the art, now known or later devised, are expressly contemplated as being equivalently within the scope of such claims. Therefore, obvious substitutions now or later known to one with ordinary skill in the art are defined to be within the scope of the defined elements.

Any claims in any subsequent application claiming priority to this application are thus to be understood to include what is specifically illustrated and described above, what is conceptually equivalent, what can be obviously substituted and also what essentially incorporates the essential idea of the invention.

We claim:

1. A method for processing sensor data representative of a scene of interest comprising the steps of:
inputting a plurality of sensor data outputs representative of a scene of interest selected from the group consisting of visible, VNIR, SWIR, MWIR, LWIR, far infrared, multi-spectral data, hyper-spectral data, SAR data, and 3-D LIDAR sensor data to a plurality of graphics processing elements,
the plurality of elements configured to independently execute a plurality of separate image processing filter operations selected from the group consisting of spatial filtering, temporal filtering, spatia-temporal filtering, and template matching,
concurrently executing the filter operations on the sensor data in each of a plurality of the elements to define a plurality of image filter outputs,
performing a cross-correlation operation on the filter outputs based on a predetermined set of filter output characteristics, and,
prioritizing one or more regions of interest (ROI) in the scene based on the cross-correlation operation.

2. The method of claim 1 wherein at least one of the image processing filter operations is selected from the group consisting of motion, intensity, color, flicker and orientation filter operations.

3. The method of claim 1 further comprising the step of annotating at least one of the regions in the scene.

4. The method of claim 3 further comprising the step of outputting at least one of the annotated scenes to a display.

5. A method for processing sensor data representative of a scene of interest comprising the steps of:
inputting a plurality of separate sensor data outputs representative of a scene of interest to a plurality of graphics processing elements,
the plurality of elements configured to independently execute a plurality of separate image processing filter operations,
concurrently executing the plurality of filter operations on the sensor data in each of a plurality of the elements to define a plurality of separate image filter outputs,
performing a cross-correlation operation on the filter outputs based on a predetermined set of filter output characteristics, and,
prioritizing one or more regions of interest (ROT) in the scene based on the cross-correlation operation.
